(19) United States
(12) Patent Application Publication
(10) Pub. No.: US 2026/0222836 A1
(43) Pub. Date: Jul. 30, 2026

(54) MANAGEMENT OF RADIO UNITS OF A DISTRIBUTED ANTENNA SYSTEM

(71) Applicant: Outdoor Wireless Networks LLC, Richardson, TX (US)

(72) Inventors: Ehsan Daeipour, Southborough, MA (US); Naveen Shanmugaraju, Bangalore (IN); Suresh N. Sriram, Bangalore (IN)

(73) Assignee: Outdoor Wireless Networks LLC, Richardson, TX (US)

(21) Appl. No.: 19/141,982

(22) PCT Filed: Dec. 21, 2023
(86) PCT No.: PCT/US2023/085451

§ 371 Date: Jun. 20, 2025

Related U.S. Application Data
(60) Provisional application No. 63/476,847, filed on Dec. 22, 2022.

(51) Int. Cl. H04W 24/02; H04L 41/0803; H04L 41/12

(52) U.S. Cl. CPC H04W 24/02; H04L 41/0803; H04L 41/12

(57) ABSTRACT

A master unit for use within a distributed antenna system includes circuitry configured to: manage a plurality of radio units of the distributed antenna system by communicating management plane messages with the plurality of radio units of the distributed antenna system; receive downlink control plane messages, downlink user plane messages, and uplink control plane messages from a distributed unit of an open radio access network; and copy and forward the downlink control plane messages, the downlink user plane messages, and the uplink control plane messages to the plurality of radio units of the distributed antenna system.

### CROSS-REFERENCE TO RELATED APPLICATIONS

This application claims the benefit of U.S. Provisional Patent Application Ser. No. 63/476,847, filed on Dec. 22, 2022 and entitled “MANAGEMENT OF RADIO UNITS OF A DISTRIBUTED ANTENNA SYSTEM”, which is hereby incorporated by reference in its entirety.

### BACKGROUND

A distributed antenna system (DAS) typically includes one or more central units or nodes that are communicatively coupled to a plurality of remotely located access points or antenna units, where each access point can be coupled directly to one or more of the central access nodes or indirectly via one or more other remote units and/or via one or more intermediary or expansion units or nodes. A DAS can use either digital transport, analog transport, or combinations of digital and analog transport for generating and communicating the transport signals between the central access nodes, the access points, and any transport expansion nodes.

### SUMMARY

A master unit for use within a distributed antenna system includes circuitry configured to: manage a plurality of radio units of the distributed antenna system by communicating management plane messages with the plurality of radio units of the distributed antenna system; receive downlink control plane messages, downlink user plane messages, and uplink control plane messages from a distributed unit of an open radio access network; and copy and forward the downlink control plane messages, the downlink user plane messages, and the uplink control plane messages to the plurality of radio units of the distributed antenna system.

A distributed antenna system includes: a master unit communicatively coupled to a distributed unit of an open radio access network implementing a shared cell; a plurality of radio units communicatively coupled to the distributed unit. Each of the plurality of radio units includes circuitry for exchanging radio frequency signals with at least one user equipment. The master unit is configured to: manage the plurality of radio units of the distributed antenna system by communicating management plane messages with the plurality of radio units; receive downlink control plane messages, downlink user plane messages, and uplink control plane messages from the distributed unit of the open radio access network; and copy and forward the downlink control plane messages, the downlink user plane messages, and the uplink control plane messages to the plurality of radio units.

A method includes: managing a plurality of radio units of a distributed antenna system by communicating management plane messages between a master unit of the distributed antenna system and the plurality of radio units of the distributed antenna system; receiving downlink control plane messages, downlink user plane messages, and uplink control plane messages from a distributed unit of an open radio access network at the master unit of the distributed antenna system; and copying and forwarding the downlink control plane messages, the downlink user plane messages, and the uplink control plane messages from the master unit of the distributed antenna system to the plurality of radio units of the distributed antenna system.

### BRIEF DESCRIPTION OF THE DRAWINGS

Understanding that the drawings depict only exemplary configurations and are not therefore to be considered limiting in scope, the exemplary configurations will be described with additional specificity and detail through the use of the accompanying drawings, in which:

FIGS. 1A-1D are block diagrams illustrating exemplary embodiments of distributed antenna systems (DAS).

FIGS. 2A-2F are block diagrams illustrating exemplary embodiments of management plane (M-plane) logical architecture for distributed antenna systems (DAS).

FIG. 3 is a flow diagram illustrating a method implemented using a distributed antenna system (DAS).

FIG. 4 is a flow diagram illustrating a method implemented using a distributed antenna system (DAS).

In accordance with common practice, the various described features are not drawn to scale but are drawn to emphasize specific features relevant to the exemplary configurations.

### DETAILED DESCRIPTION

The Open Radio Access Network (O-RAN) promulgates standards using O-RAN specification. The O-RAN specifications define a “Shared Cell” configuration or implementation in which a single cell is served using multiple RUs. The O-RAN shared cell implementation attempts to make more efficient use of bandwidth to and from DUs (compared to O-RAN 1.0) in order to support communicating front-haul data with the multiple RUs. The O-RAN shared cell implementation is described in detail at Section 13 “Support of Shared Cell” in the O-RAN Working Group 4 (Open Fronthaul Interfaces WG) Control, User and Synchronization Plane Specification version 10.0 from October 2022 (O-RAN.WG4.CUS.0-v10.00, hereinafter “Support of Shared Cell O-RAN Specification”, available at pages 252-270 of PDF at https://orandownloadsweb.azurewebsites.net/download?id=364). In the O-RAN shared cell implementation, there are generally two modes of operation in the fronthaul: Fronthaul Multiplexer (FHM) mode and Cascade mode. Examples implementing a shared cell include a FHM in order to more efficiently support one-DU-to-many-RU mapping.

In examples including an FHM, the FHM can be modelled as a RU with lower-layer split (LLS) fronthaul support (similar to a standard O-RU) along with copy and combine function (additional to standard O-RU), but without radio transmission/reception capability. In examples, the FHM: (1) replicates the downlink packet stream (from the DU) for each RU; and (2) uses combining/digital summation on the uplink packet stream from the RUs (before sending to the DU). The combining/digital summation includes: (1) adding the corresponding in-phase (I) samples in corresponding physical resource blocks (PRBs) (from all the RUs); (2) adding the corresponding quadrature-phase (Q) samples in corresponding PRBs (from all the RUs); and (3) sending a combined stream of I/Q data from the FHM to the DU. The combining/digital summation may optionally include some overflow management. Using the shared cell implementation, the DU can send and receive a single packet stream (with a bandwidth of approximately N PRBs) instead of M packet streams (one for each RU with a total bandwidth of approximately N PRBs×M RUs). By reducing the DU transmitted and received data to a single stream of N PRBs, the shared cell implementation reduces bandwidth (between the DU and multiple RUs).

In examples, using the FHM mode shared cell implementation requires the use of a FHM. A FHM may be limited in how many RUs can connect to it. In examples, multiple FHM are cascaded from one another to support larger quantities of RUs. FHM mode operations may also be limited to star topology and hybrid Cascade FHM modes. In Cascade mode, the RUs are arranged in a daisy-chain where each Cascade mode RU can also provide copy-and-combine functionality with all the additional functionalities of an RU at minimum extra processing cost. Cascade mode RUs act as copy-and-forward nodes from north to south for downlink and combine-and-forward nodes in the uplink. In examples, multicast is used in the downlink to reduce fronthaul bandwidth and unicast is used in the uplink.

While Shared Cell in O-RAN allows for multiple RUs to be included in the same cell, the concept is different from the way a distributed antenna system (DAS) functions. In O-RAN Shared Cell, the DU is aware of all RUs and responsible for full management of all the RUs. In contrast with DAS, the base station source is typically agnostic to the number of RUs and their locations. In examples, the Shared Cell related intelligence is moved from the DU to a master unit (MU) of the DAS. In examples, a DU connected to a DAS with Shared Cell related intelligence in the master unit of the DAS can interface with the specifically configured master unit as if it were a single RU. In examples, the DU is not required to have any additional intelligence in its M-plane or CU-planes for multiple RUs.

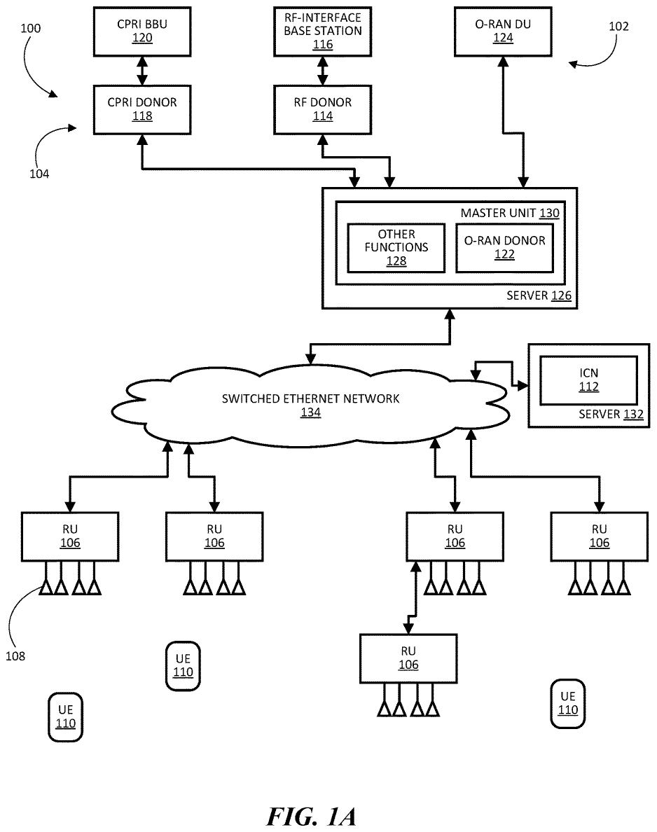

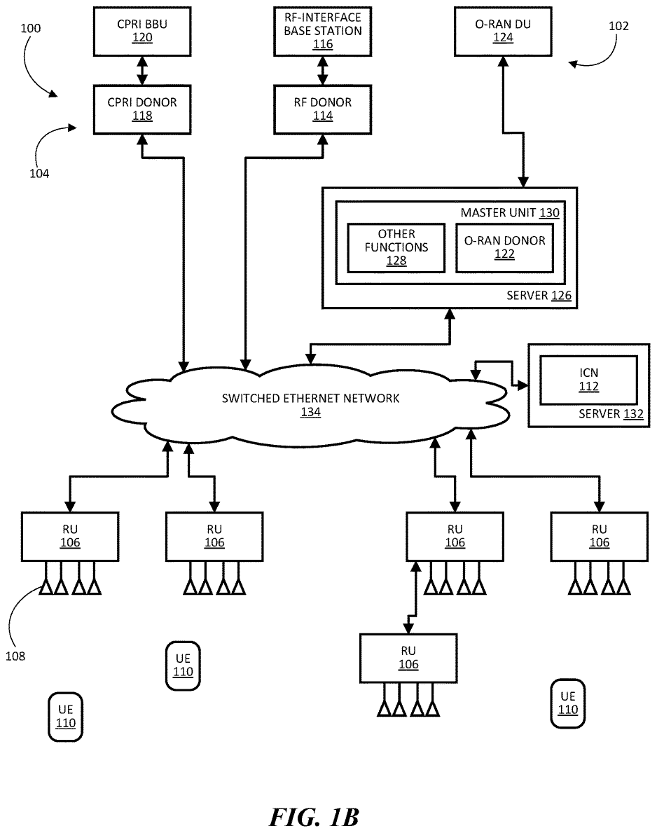

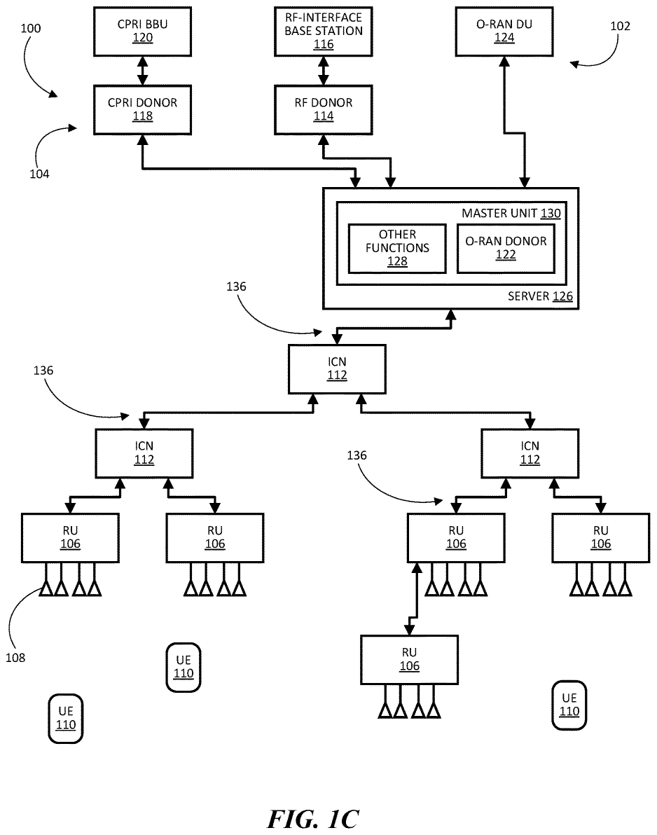

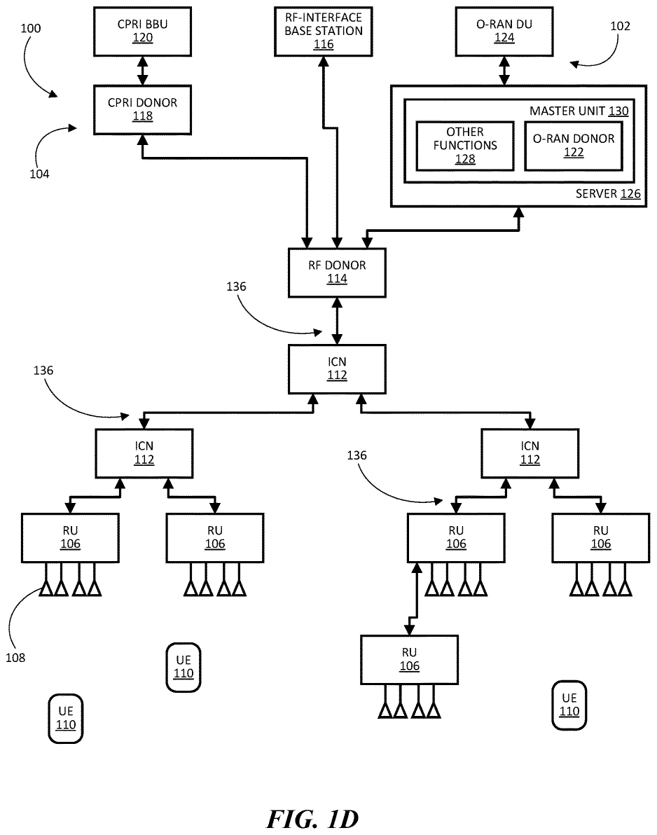

FIG. 1A is a block diagram illustrating an exemplary embodiment of a distributed antenna system (DAS) 100 that is configured to serve one or more base stations 102. In the exemplary embodiment shown in FIG. 1A, the DAS 100 includes one or more donor units 104 that are used to couple the DAS 100 to the base stations 102. The DAS 100 also includes a plurality of remotely located radio units (RUs) 106 (also referred to as “antenna units,” “access points,” “remote units,” or “remote antenna units”). The RUs 106 are communicatively coupled to the donor units 104.

Each RU 106 includes, or is otherwise associated with, a respective set of coverage antennas 108 via which downlink analog RF signals can be radiated to user equipment (UEs) 110 and via which uplink analog RF signals transmitted by UEs 110 can be received. The DAS 100 is configured to serve each base station 102 using a respective subset of RUs 106 (which may include less than all of the RUs 106 of the DAS 100). Also, the subsets of RUs 106 used to serve the base stations 102 may differ from base station 102 to base station 102. The subset of RUs points 106 used to serve a given base station 102 is also referred to here as the “simulcast zone” for that base station 102. In general, the wireless coverage of a base station 102 served by the DAS 100 is improved by radiating a set of downlink RF signals for that base station 102 from the coverage antennas 108 associated with the multiple RUs 106 in that base station's simulcast zone and by producing a single “combined” set of uplink base station signals or data that is provided to that base station 102. The single combined set of uplink base station signals or data is produced by a combining or summing process that uses inputs derived from the uplink RF signals received via the coverage antennas 108 associated with the RUs 106 in that base station's simulcast zone.

The DAS 100 can also include one or more intermediary combining nodes (ICNs) 112 (also referred to as “expansion” units or nodes). For each base station 102 served by a given ICN 112, the ICN 112 is configured to receive a set of uplink transport data for that base station 102 from a group of “southbound” entities (that is, from RUs 106 and/or other ICNs 112) and generate a single set of combined uplink transport data for that base station 102, which the ICN 112 transmits “northbound” towards the donor unit 104 serving that base station 102. The single set of combined uplink transport data for each served base station 102 is produced by a combining or summing process that uses inputs derived from the uplink RF signals received via the coverage antennas 108 of any southbound RUs 106 included in that base station's simulcast zone. As used here, “southbound” refers to traveling in a direction “away,” or being relatively “farther,” from the donor units 104 and base stations 102, and “northbound” refers to traveling in a direction “towards”, or being relatively “closer” to, the donor units 104 and base stations 102.

In some configurations, each ICN 112 also forwards downlink transport data to the group of southbound RUs 108s and/or ICNs 112 served by that ICN 112. Generally, ICNs 112 can be used to increase the number of RUs 106 that can be served by the donor units 104 while reducing the processing and bandwidth load relative to having the additional RUs 106 communicate directly with each such donor unit 104.

Also, one or more RUs 106 can be configured in a “daisy-chain” or “ring” configuration in which transport data for at least some of those RUs 106 is communicated via at least one other RU 106. Each RU 106 would also perform the combining or summing process for any base station 102 that is served by that RU 106 and one or more of the southbound entities subtended from that RU 106. (Such a RU 106 also forwards northbound all other uplink transport data received from its southbound entities.)

The DAS 100 can include various types of donor units 104. One example of a donor unit 104 is an RF donor unit 114 that is configured to couple the DAS 100 to a base station 116 using the external analog radio frequency (RF) interface of the base station 116 that would otherwise be used to couple the base station 116 to one or more antennas (if the DAS 100 were not being used). This type of base station 116 is also referred to here as an “RF-interface” base station 116. An RF-interface base station 116 can be coupled to a corresponding RF donor unit 114 by coupling each antenna port of the base station 116 to a corresponding port of the RF donor unit 114.

Each RF donor unit 114 serves as an interface between each served RF-interface base station 116 and the rest of the DAS 100 and receives downlink base station signals from, and outputs uplink base station signals to, each served RF-interface base station 116. Each RF donor unit 114 performs at least some of the conversion processing necessary to convert the base station signals to and from the digital fronthaul interface format natively used in the DAS 100 for communicating time-domain baseband data. The downlink and uplink base station signals communicated between the RF-interface base station 116 and the donor unit 114 are analog RF signals. Also, in this example, the digital fronthaul interface format natively used in the DAS 100 for communicating time-domain baseband data can comprise the O-RAN fronthaul interface, a CPRI or enhanced CPRI (eCPRI) digital fronthaul interface format, or a proprietary digital fronthaul interface format (though other digital fronthaul interface formats can also be used).

Another example of a donor unit 104 is a digital donor unit that is configured to communicatively couple the DAS 100 to a baseband entity using a digital baseband fronthaul interface that would otherwise be used to couple the baseband entity to a radio unit (if the DAS 100 were not being used). In the example shown in FIG. 1A, two types of digital donor units are shown.

The first type of digital donor unit comprises a digital donor unit 118 that is configured to communicatively couple the DAS 100 to a baseband unit (BBU) 120 using a time-domain baseband fronthaul interface implemented in accordance with a Common Public Radio Interface (“CPRI”) specification. This type of digital donor unit 118 is also referred to here as a “CPRI” donor unit 118, and this type of BBU 120 is also referred to here as a CPRI BBU 120. For each CPRI BBU 120 served by a CPRI donor unit 118, the CPRI donor unit 118 is coupled to the CPRI BBU 120 using the CPRI digital baseband fronthaul interface that would otherwise be used to couple the CPRI BBU 120 to a CPRI remote radio head (RRH) (if the DAS 100 were not being used). A CPRI BBU 120 can be coupled to a corresponding CPRI donor unit 118 via a direct CPRI connection.

Each CPRI donor unit 118 serves as an interface between each served CPRI BBU 120 and the rest of the DAS 100 and receives downlink base station signals from, and outputs uplink base station signals to, each CPRI BBU 120. Each CPRI donor unit 118 performs at least some of the conversion processing necessary to convert the CPRI base station data to and from the digital fronthaul interface format natively used in the DAS 100 for communicating time-domain baseband data. The downlink and uplink base station signals communicated between each CPRI BBU 120 and the CPRI donor unit 118 comprise downlink and uplink fronthaul data generated and formatted in accordance with the CPRI baseband fronthaul interface.

The second type of digital donor unit comprises a digital donor unit 122 that is configured to communicatively couple the DAS 100 to an O-RAN DU 124 using a frequency-domain baseband fronthaul interface implemented in accordance with a O-RAN Alliance specification. The acronym “O-RAN” is an abbreviation for “Open Radio Access Network.” This type of digital donor unit 122 is also referred to here as an “O-RAN” donor unit 122, and this type of O-RAN DU 124 is typically an O-RAN distributed unit (DU) and is also referred to here as an O-RAN DU 124. For each O-RAN DU 124 served by a O-RAN donor unit 122, the O-RAN donor unit 122 is coupled to the O-DU 124 using the O-RAN digital baseband fronthaul interface that would otherwise be used to couple the O-RAN DU 124 to a O-RAN RU (if the DAS 100 were not being used). An O-RAN DU 124 can be coupled to a corresponding O-RAN donor unit 122 via a switched Ethernet network. Alternatively, an O-RAN DU 124 can be coupled to a corresponding O-RAN donor unit 122 via a direct Ethernet or enhanced CPRI (eCPRI) connection.

Each O-RAN donor unit 122 serves as an interface between each served O-RAN DU 124 and the rest of the DAS 100 and receives downlink base station signals from, and outputs uplink base station signals to, each O-RAN DU 124. Each O-RAN donor unit 122 performs at least some of any conversion processing necessary to convert the base station signals to and from the digital fronthaul interface format natively used in the DAS 100 for communicating frequency-domain baseband data. The downlink and uplink base station signals communicated between each O-RAN DU 124 and the O-RAN donor unit 122 comprise downlink and uplink fronthaul data generated and formatted in accordance with the O-RAN baseband fronthaul interface, where the user plane data comprises frequency-domain baseband IQ data. Also, in this example, the digital fronthaul interface format natively used in the DAS 100 for communicating O-RAN fronthaul data is the same O-RAN fronthaul interface used for communicating base station signals between each O-RAN DU 124 and the O-RAN donor unit 122, and the “conversion” performed by each O-RAN donor unit 122 (and/or one or more other entities of the DAS 100) includes performing any needed “multicasting” of the downlink data received from each O-RAN DU 124 to the multiple RUs 106 in a simulcast zone for that O-RAN DU 124 (for example, by communicating the downlink fronthaul data to an appropriate multicast address and/or by copying the downlink fronthaul data for communication over different fronthaul links) and performing any needed combining or summing of the uplink data received from the RUs 106 to produce combined uplink data provided to the O-RAN DU 124. It is to be understood that other digital fronthaul interface formats can also be used.

In general, the various base stations 102 are configured to communicate with a core network (not shown) of the associated wireless operator using an appropriate backhaul network (typically, a public wide area network such as the Internet). Also, the various base stations 102 may be from multiple, different wireless operators and/or the various base stations 102 may support multiple, different wireless protocols and/or RF bands.

In general, for each base station 102, the DAS 100 is configured to receive a set of one or more downlink base station signals from the base station 102 (via an appropriate donor unit 104), generate downlink transport data derived from the set of downlink base station signals, and transmit the downlink transport data to the RUs 106 in the base station's simulcast zone. For each base station 102 served by a given RU 106, the RU 106 is configured to receive the downlink transport data transmitted to it via the DAS 100 and use the received downlink transport data to generate one or more downlink analog radio frequency signals that are radiated from one or more coverage antennas 108 associated with that RU 106 for reception by user equipment 110. In this way, the DAS 100 increases the coverage area for the downlink capacity provided by the base stations 102. Also, for any southbound entities (for example, southbound RUs 106 or ICNs 112) coupled to the RU 106 (for example, in a daisy chain or ring architecture), the RU 106 forwards any downlink transport data intended for those southbound entities towards them.

For each base station 102 served by a given RU 106, the RU 106 is configured to receive one or more uplink radio frequency signals transmitted from the user equipment 110. These signals are analog radio frequency signals and are received via the coverage antennas 108 associated with that RU 106. The RU 106 is configured to generate uplink transport data derived from the one or more remote uplink radio frequency signals received for the served base station 102 and transmit the uplink transport data northbound towards the donor unit 104 coupled to that base station 102.

For each base station 102 served by the DAS 100, a single “combined” set of uplink base station signals or data is produced by a combining or summing process that uses inputs derived from the uplink RF signals received via the RUs 106 in that base station's simulcast zone. The resulting final single combined set of uplink base station signals or data is provided to the base station 102. This combining or summing process can be performed in a centralized manner in which the combining or summing process is performed by a single unit of the DAS 100 (for example, a donor unit 104 or master unit 130). This combining or summing process can also be performed in a distributed or hierarchical manner in which the combining or summing process is performed by multiple units of the DAS 100 (for example, a donor unit 104 (or master unit 130) and one or more ICNs 112 and/or RUs 106). Each unit of the DAS 100 that performs the combining or summing process for a given base station 102 receives uplink transport data from that unit's southbound entities and uses that data to generate combined uplink transport data, which the unit transmits northbound towards the base station 102. The generation of the combined uplink transport data involves, among other things, extracting in-phase and quadrature (IQ) data from the received uplink transport data and performing a combining or summing process using any uplink IQ data for that base station 102 in order to produce combined uplink IQ data.

Some of the details regarding how base station signals or data are communicated and transport data is produced vary based on which type of base station 102 is being served. In the case of an RF-interface base station 116, the associated RF donor unit 114 receives analog downlink RF signals from the RF-interface base station 116 and, either alone or in combination with one or more other units of the DAS 100, converts the received analog downlink RF signals to the digital fronthaul interface format natively used in the DAS 100 for communicating time-domain baseband data (for example, by digitizing, digitally down-converting, and filtering the received analog downlink RF signals in order to produce digital baseband IQ data and formatting the resulting digital baseband IQ data into packets) and communicates the resulting packets of downlink transport data to the various RUs 106 in the simulcast zone of that base station 116. The RUs 106 in the simulcast zone for that base station 116 receive the downlink transport data and use it to generate and radiate downlink RF signals as described above. In the uplink, either alone or in combination with one or more other units of the DAS 100, the RF donor unit 114 generates a set of uplink base station signals from uplink transport data received by the RF donor unit 114 (and/or the other units of the DAS 100 involved in this process). The set of uplink base station signals is provided to the served base station 116. The uplink transport data is derived from the uplink RF signals received at the RUs 106 in the simulcast zone of the served base station 116 and communicated in packets.

In the case of a CPRI BBU 120, the associated CPRI digital donor unit 118 receives CPRI downlink fronthaul data from the CPRI BBU 120 and, either alone or in combination with another unit of the DAS 100, converts the received CPRI downlink fronthaul data to the digital fronthaul interface format natively used in the DAS 100 for communicating time-domain baseband data (for example, by re-sampling, synchronizing, combining, separating, gain adjusting, etc. the CPRI baseband IQ data, and formatting the resulting baseband IQ data into packets), and communicates the resulting packets of downlink transport data to the various RUs 106 in the simulcast zone of that CPRI BBU 120. The RUs 106 in the simulcast zone of that CPRI BBU 120 receive the packets of downlink transport data and use them to generate and radiate downlink RF signals as described above. In the uplink, either alone or in combination with one or more other units of the DAS 100, the CPRI donor unit 118 generates uplink base station data from uplink transport data received by the CPRI donor unit 118 (and/or the other units of the DAS 100 involved in this process). The resulting uplink base station data is provided to that CPRI BBU 120. The uplink transport data is derived from the uplink RF signals received at the RUs 106 in the simulcast zone of the CPRI BBU 120.

In the case of an O-RAN DU 124, the associated O-RAN donor unit 122 receives packets of O-RAN downlink fronthaul data (that is, O-RAN user plane and control plane messages) from each O-RAN DU 124 coupled to that O-RAN digital donor unit 122 and, either alone or in combination with another unit of the DAS 100, converts (if necessary) the received packets of O-RAN downlink fronthaul data to the digital fronthaul interface format natively used in the DAS 100 for communicating O-RAN baseband data and communicates the resulting packets of downlink transport data to the various RUs 106 in a simulcast zone for that ORAN DU 124. The RUs 106 in the simulcast zone of each O-RAN DU 124 receive the packets of downlink transport data and use them to generate and radiate downlink RF signals as described above. In the uplink, either alone or in combination with one or more other units of the DAS 100, the O-RAN donor unit 122 generates packets of uplink base station data from uplink transport data received by the O-RAN donor unit 122 (and/or the other units of the DAS 100 involved in this process). The resulting packets of uplink base station data are provided to the O-RAN DU 124. The uplink transport data is derived from the uplink RF signals received at the RUs 106 in the simulcast zone of the served O-RAN DU 124 and communicated in packets.

In one implementation, one of the units of the DAS 100 is also used to implement a “master” timing entity for the DAS 100 (for example, such a master timing entity can be implemented as a part of a master unit 130 described below). In another example, a separate, dedicated timing master entity (not shown) is provided within the DAS 100. In either case, the master timing entity synchronizes itself to an external timing master entity (for example, a timing master associated with one or more of the O-DUs 124) and, in turn, that entity serves as a timing master entity for the other units of the DAS 100. A time synchronization protocol (for example, the Institute of Electrical and Electronics Engineers (IEEE) 1588 Precision Time Protocol (PTP), the Network Time Protocol (NTP), or the Synchronous Ethernet (SyncE) protocol) can be used to implement such time synchronization.

A management system (not shown) can be used to manage the various nodes of the DAS 100. In one implementation, the management system communicates with a predetermined “master” entity for the DAS 100 (for example, the master unit 130 described below), which in turns forwards or otherwise communicates with the other units of the DAS 100 for management plane purposes. In another implementation, the management system communicates with the various units of the DAS 100 directly for management plane purposes (that is, without using a master entity as a gateway).

Each base station 102 (including each RF-interface base station 116, CPRI BBU 120, and O-RAN DU 124), donor unit 104 (including each RF donor unit 114, CPRI donor unit 118, and O-RAN donor unit 122), RU 106, ICN 112, and any of the specific features described here as being implemented thereby, can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented by the software. Such hardware or software (or portions thereof) can be implemented in other ways (for example, in an application specific integrated circuit (ASIC), field programmable gate array (FPGA), etc.). Such entities can be implemented in other ways.

The DAS 100 can be implemented in a virtualized manner or a non-virtualized manner. When implemented in a virtualized manner, one or more nodes, units, or functions of the DAS 100 are implemented using one or more virtual network functions (VNFs) executing on one or more physical server computers (also referred to here as “physical servers” or just “servers”) (for example, one or more commercial-off-the-shelf (COTS) servers of the type that are deployed in data centers or “clouds” maintained by enterprises, communication service providers, or cloud services providers). More specifically, in the exemplary embodiment shown in FIG. 1A, each O-RAN donor unit 122 is implemented as a VNF running on a server 126. The server 126 can execute other VNFs 128 that implement other functions for the DAS 100 (for example, fronthaul, management plane, and synchronization plane functions). The various VNFs executing on the server 126 are also referred to here as “master unit” functions 130 or, collectively, as the “master unit” 130. Also, in the exemplary embodiment shown in FIG. 1A, each ICN 112 is implemented as a VNF running on a server 132.

The RF donor units 114 and CPRI donor units 118 can be implemented as cards (for example, Peripheral Component Interconnect (PCI) Cards) that are inserted in the server 126. Alternatively, the RF donor units 114 and CPRI donor units 118 can be implemented as separate devices that are coupled to the server 126 via dedicated Ethernet links or via a switched Ethernet network (for example, the switched Ethernet network 134 described below).

In the exemplary embodiment shown in FIG. 1A, the donor units 104, RUs 106 and ICNs 112 are communicatively coupled to one another via a switched Ethernet network 134. Also, in the exemplary embodiment shown in FIG. 1A, an O-RAN DU 124 can be coupled to a corresponding O-RAN donor unit 122 via the same switched Ethernet network 134 used for communication within the DAS 100 (though each O-RAN DU 124 can be coupled to a corresponding O-RAN donor unit 122 in other ways). In the exemplary embodiment shown in FIG. 1A, the downlink and uplink transport data communicated between the units of the DAS 100 is formatted as O-RAN data that is communicated in Ethernet packets over the switched Ethernet network 134.

In the exemplary embodiment shown in FIG. 1A, the RF donor units 114 and CPRI donor units 118 are coupled to the RUs 106 and ICNs 112 via the master unit 130.

In the downlink, the RF donor units 114 and CPRI donor units 118 provide downlink time-domain baseband IQ data to the master unit 130. The master unit 130 generates downlink O-RAN user plane messages containing downlink baseband IQ that is either the time-domain baseband IQ data provided from the donor units 114 and 118 or is derived therefrom (for example, where the master unit 130 converts the received time-domain baseband IQ data into frequency-domain baseband IQ data). The master unit 130 also generates corresponding downlink O-RAN control plane messages for those O-RAN user plane messages. The resulting downlink O-RAN user plane and control plane messages are communicated (multicasted) to the RUs 106 in the simulcast zone of the corresponding base station 102 via the switched Ethernet network 134.

In the uplink, for each RF-interface base station 116 and CPRI BBU 120, the master unit 130 receives O-RAN uplink user plane messages for the base station 116 or CPRI BBU 120 and performs a combining or summing process using the uplink baseband IQ data contained in those messages in order to produce combined uplink baseband IQ data, which is provided to the appropriate RF donor unit 114 or CPRI donor unit 118. The RF donor unit 114 or CPRI donor unit 118 uses the combined uplink baseband IQ data to generate a set of base station signals or CPRI data that is communicated to the corresponding RF-interface base station 116 or CPRI BBU 120. If time-domain baseband IQ data has been converted into frequency-domain baseband IQ data for transport over the DAS 100, the donor unit 114 or 118 also converts the combined uplink frequency-domain IQ data into combined uplink time-domain IQ data as part of generating the set of base station signals or CPRI data that is communicated to the corresponding RF-interface base station 116 or CPRI BBU 120.

In the exemplary embodiment shown in FIG. 1A, the master unit 130 (more specifically, the O-RAN donor unit 122) receives downlink O-RAN user plane and control plane messages from each served O-RAN DU 124 and communicates (multicasts) them to the RUs 106 in the simulcast zone of the corresponding O-RAN DU 124 via the switched Ethernet network 134. In the uplink, the master unit 130 (more specifically, the O-RAN donor unit 122) receives O-RAN uplink user plane messages for each served O-RAN DU 124 and performs a combining or summing process using the uplink baseband IQ data contained in those messages in order to produce combined uplink IQ data. The O-RAN donor unit 122 produces O-RAN uplink user plane messages containing the combined uplink baseband IQ data and communicates those messages to the O-RAN DU 124.

In the exemplary embodiment shown in FIG. 1A, only uplink transport data is communicated using the ICNs 112, and downlink transport data is communicated from the master unit 130 to the RUs 106 without being forwarded by, or otherwise communicated using, the ICNs 112.

FIG. 1B illustrates another exemplary embodiment of a DAS 100. The DAS 100 shown in FIG. 1B is the same as the DAS 100 shown in FIG. 1A except as described below. In the exemplary embodiment shown in FIG. 1B, the RF donor unit 114 and CPRI donor unit 118 are coupled directly to the switched Ethernet network 134 and not via the master unit 130, as is the case in the embodiment shown in FIG. 1A.

As described above, in the exemplary embodiment shown in FIG. 1A, the master unit 130 performs some transport functions related to serving the RF-interface base stations 116 and CPRI BBUs 120 coupled to the donor units 114 and 118. In the exemplary embodiment shown in FIG. 1B, the RF donor units 114 and CPRI donor units 118 perform those transport functions (that is, the RF donor units 114 and CPRI donor units 118 perform all of the transport functions related to serving the RF-interface base stations 116 and CPRI BBUs 120, respectively).

FIG. 1C illustrates another exemplary embodiment of a DAS 100. The DAS 100 shown in FIG. 1C is the same as the DAS 100 shown in FIG. 1A except as described below. In the exemplary embodiment shown in FIG. 1C, the donor units 104, RUs 106 and ICNs 112 are communicatively coupled to one another via point-to-point Ethernet links 136 (instead of a switched Ethernet network). Also, in the exemplary embodiment shown in FIG. 1C, an O-RAN DU 124 can be coupled to a corresponding O-RAN donor unit 122 via a switched Ethernet network (not shown in FIG. 1C), though that switched Ethernet network is not used for communication within the DAS 100. In the exemplary embodiment shown in FIG. 1C, the downlink and uplink transport data communicated between the units of the DAS 100 is communicated in Ethernet packets over the point-to-point Ethernet links 136.

For each southbound point-to-point Ethernet link 136 that couples a master unit 130 to an ICN 112, the master unit 130 assembles downlink transport frames and communicates them in downlink Ethernet packets to the ICN 112 over the point-to-point Ethernet link 136. For each point-to-point Ethernet link 136, each downlink transport frame multiplexes together downlink time-domain baseband IQ data and Ethernet data that needs to be communicated to southbound RUs 106 and ICNs 112 that are coupled to the master unit 130 via that point-to-point Ethernet link 136. The downlink time-domain baseband IQ data is sourced from one or more RF donor units 114 and/or CPRI donor units 118. The Ethernet data comprises downlink user plane and control plane O-RAN fronthaul data sourced from one or more O-RAN donor units 122 and/or management plane data sourced from one or more management entities for the DAS 100. That is, this Ethernet data is encapsulated into downlink transport frames that are also used to communicate downlink time-domain baseband IQ data and this Ethernet data is also referred to here as “encapsulated” Ethernet data. The resulting downlink transport frames are communicated in the payload of downlink Ethernet packets communicated from the master unit 130 to the ICN 112 over the point-to-point Ethernet link 136. The Ethernet packets into which the encapsulated Ethernet data is encapsulated are also referred to here as “transport” Ethernet packets.

Each ICN 112 receives downlink transport Ethernet packets via each northbound point-to-point Ethernet link 136 and extracts any downlink time-domain baseband IQ data and/or encapsulated Ethernet data included in the downlink transport frames communicated via the received downlink transport Ethernet packets. Any encapsulated Ethernet data that is intended for the ICN 112 (for example, management plane Ethernet data) is processed by the ICN 112.

For each southbound point-to-point Ethernet link 136 coupled to the ICN 112, the ICN 112 assembles downlink transport frames and communicates them in downlink Ethernet packets to the southbound entities subtended from the ICN 112 via the point-to-point Ethernet link 136. For each southbound point-to-point Ethernet link 136, each downlink transport frame multiplexes together downlink time-domain baseband IQ data and Ethernet data received at the ICN 112 that needs to be communicated to those subtended southbound entities. The resulting downlink transport frames are communicated in the payload of downlink transport Ethernet packets communicated from the ICN 112 to those subtended southbound entities ICN 112 over the point-to-point Ethernet link 136.

Each RU 106 receives downlink transport Ethernet packets via each northbound point-to-point Ethernet link 136 and extracts any downlink time-domain baseband IQ data and/or encapsulated Ethernet data included in the downlink transport frames communicated via the received downlink transport Ethernet packets. As described above, the RU 106 uses any downlink time-domain baseband IQ data and/or downlink O-RAN user plane and control plane fronthaul messages to generate downlink RF signals for radiation from the set of coverage antennas 108 associated with that RU 106. The RU 106 processes any management plane messages communicated to that RU 106 via encapsulated Ethernet data.

Also, for any southbound point-to-point Ethernet link 136 coupled to the RU 106, the RU 106 assembles downlink transport frames and communicates them in downlink Ethernet packets to the southbound entities subtended from the RU 106 via the point-to-point Ethernet link 136. For each southbound point-to-point Ethernet link 136, each downlink transport frame multiplexes together downlink time-domain baseband IQ data and Ethernet data received at the RU 106 that needs to be communicated to those subtended southbound entities. The resulting downlink transport frames are communicated in the payload of downlink transport Ethernet packets communicated from the RU 106 to those subtended southbound entities ICN 112 over the point-to-point Ethernet link 136.

In the uplink, each RU 106 generates uplink time-domain baseband IQ data and/or uplink O-RAN user plane fronthaul messages for each RF-interface base station 116, CPRI BBU 120, and/or O-RAN DU 124 served by that RU 106 as described above. For each northbound point-to-point Ethernet link 136 of the RU 106, the RU 106 assembles uplink transport frames and communicates them in uplink transport Ethernet packets northbound towards the appropriate master unit 130 via that point-to-point Ethernet link 136. For each northbound point-to-point Ethernet link 136, each uplink transport frame multiplexes together uplink time-domain baseband IQ data originating from that RU 106 and/or any southbound entity subtended from that RU 106 as well as any Ethernet data originating from that RU 106 and/or any southbound entity subtended from that RU 106. In connection with doing this, the RU 106 performs the combining or summing process described above for any base station 102 served by that RU 106 and also by one or more of the subtended entities. (The RU 106 forwards northbound all other uplink data received from those southbound entities.) The resulting uplink transport frames are communicated in the payload of uplink transport Ethernet packets northbound towards the master unit 130 via the associated point-to-point Ethernet link 136.

Each ICN 112 receives uplink transport Ethernet packets via each southbound point-to-point Ethernet link 136 and extracts any uplink time-domain baseband IQ data and/or encapsulated Ethernet data included in the uplink transport frames communicated via the received uplink transport Ethernet packets. For each northbound point-to-point Ethernet link 136 coupled to the ICN 112, the ICN 112 assembles uplink transport frames and communicates them in uplink transport Ethernet packets northbound towards the master unit 130 via that point-to-point Ethernet link 136. For each northbound point-to-point Ethernet link 136, each uplink transport frame multiplexes together uplink time-domain baseband IQ data and Ethernet data received at the ICN 112 that needs to be communicated northbound towards the master unit 130. The resulting uplink transport frames are communicated in the payload of uplink transport Ethernet packets communicated northbound towards the master unit 130 over the point-to-point Ethernet link 136.

Each master unit 130 receives uplink transport Ethernet packets via each southbound point-to-point Ethernet link 136 and extracts any uplink time-domain baseband IQ data and/or encapsulated Ethernet data included in the uplink transport frames communicated via the received uplink transport Ethernet packets. Any extracted uplink time-domain baseband IQ data, as well as any uplink O-RAN messages communicated in encapsulated Ethernet, is used in producing a single “combined” set of uplink base station signals or data for the associated base station 102 as described above (which includes performing the combining or summing process). Any other encapsulated Ethernet data (for example, management plane Ethernet data) is forwarded on towards the respective destination (for example, a management entity).

In the exemplary embodiment shown in FIG. 1C, synchronization plane messages are communicated using native Ethernet packets (that is, non-encapsulated Ethernet packets) that are interleaved between the transport Ethernet packets.

FIG. 1D illustrates another exemplary embodiment of a DAS 100. The DAS 100 shown in FIG. 1C is the same as the DAS 100 shown in FIG. 1C except as described below. In the exemplary embodiment shown in FIG. 1D, the CPRI donor units 118, O-RAN donor unit 122, and master unit 130 are coupled to the RUs 106 and ICNs 112 via one or more RF units 114. That is, each RF unit 114 performs the transport frame multiplexing and demultiplexing that is described above in connection with FIG. 1C as being performed by the master unit 130.

When the DAS 100 of any of FIGS. 1A-1D is virtualized as a virtualized DAS (vDAS) 100, virtualization software is executed to implement at least one virtual network function (VNF) running on a server 126. While a single server 126 is shown, it is understood that the at least one virtual network function (VNF) can be implemented using any number of physical servers 126 and that these physical servers can be commercial-off-the-shelf (COTS) hardware. In examples, a single server may host multiple virtual network functions (VNFs). In this description, it should be understood that references to “virtualization” are intended to refer to, and include within their scope, any type of virtualization technology, including “container” based virtualization technology (such as, but not limited to, Kubernetes). In examples, the at least one VNF is implemented using at least one virtual entity (such as Kubernetes Pods, virtual machine(s), container(s), etc.) referred to herein as a vDAS container. In examples, each vDAS container is implemented in a Pod in Kubernetes virtualization environment. In other examples, container or other computing entities are used instead of Kubernetes Pods.

When the DAS 100 of any of FIGS. 1A-1D is virtualized as a vDAS 100, it is especially well-suited for use in deployments in which base stations from multiple wireless service operators share the same vDAS 100 (including, for example, neutral host deployments or deployments where one wireless service operator owns the vDAS 100 and provides other wireless service operators with access to its vDAS 100). The vDAS 100 described here is especially well-suited for use in such deployments because additional virtualized components be easily instantiated in order to support additional wireless service operators. This is the case even if an additional physical server 126 is needed in order to instantiate additional virtualized components because a physical server 126 is either already available in such deployments or can be easily added at a low cost (for example, because of the COTS nature of such hardware).

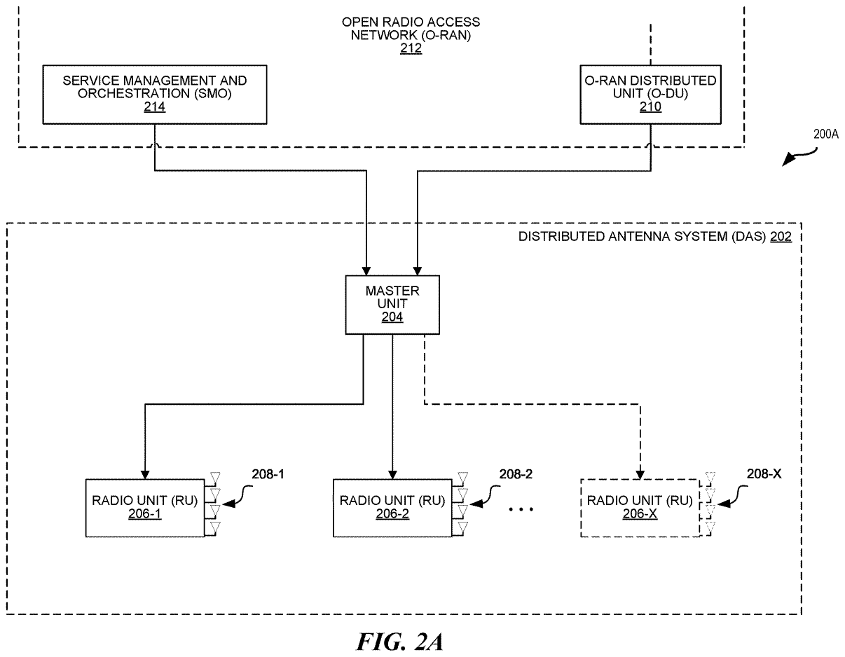

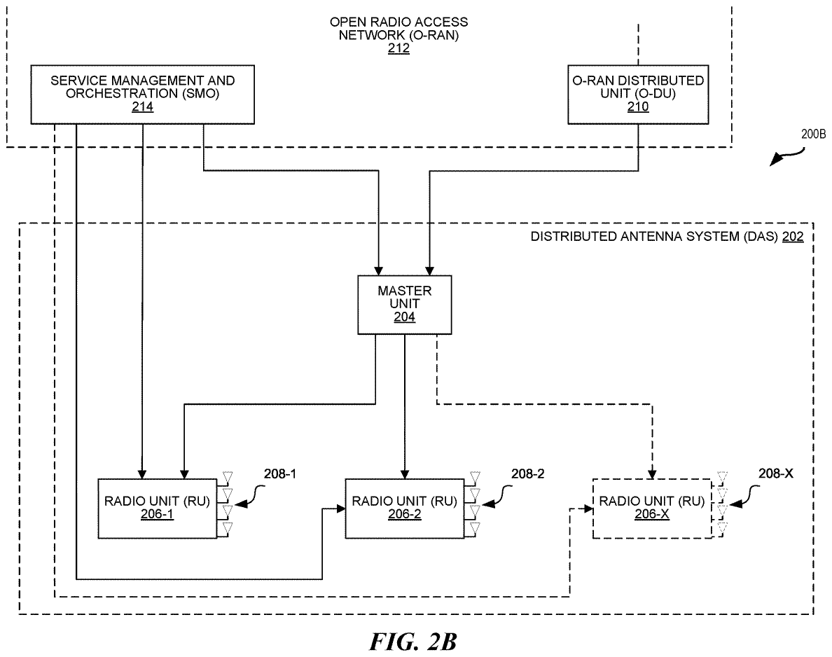

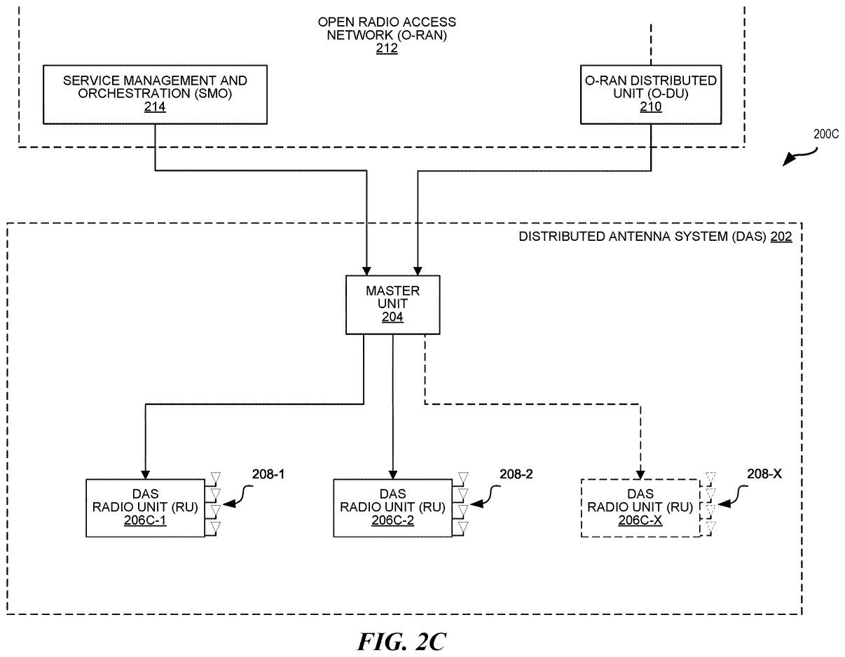

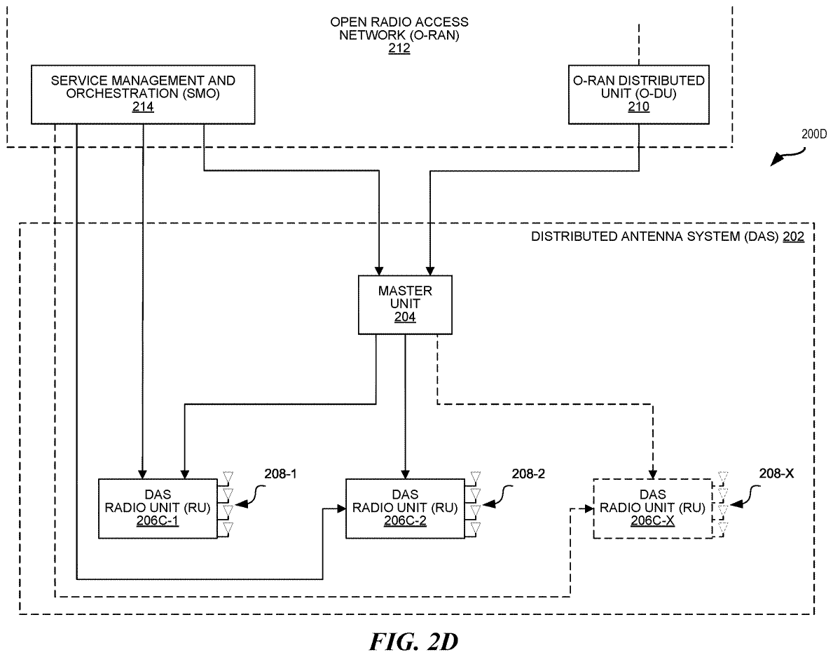

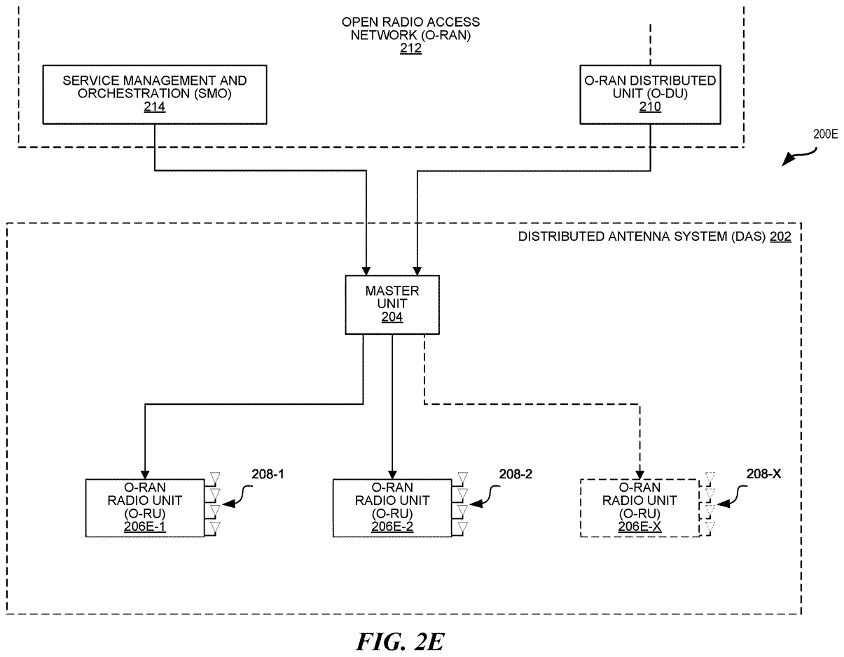

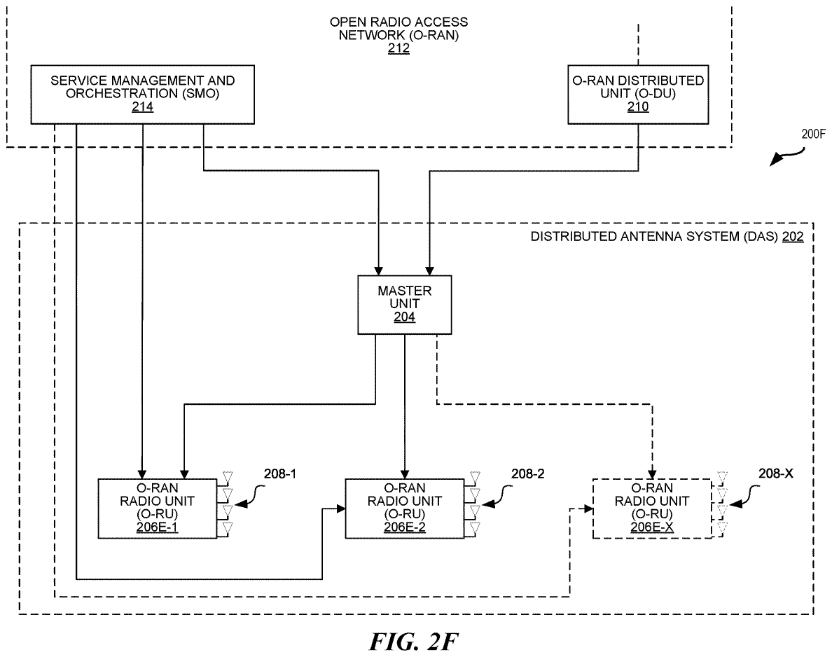

FIGS. 2A-2F are block diagrams illustrating exemplary embodiments of management plane (M-plane) logical architecture for distributed antenna systems (DAS).

The connecting lines in FIGS. 2A-2F show the logical communication flow of management plane (M-plane) messages. While separate lines are not drawn for the logical communication flow of control plane (C-plane) messages, user plane (U-plane) messages, or synchronization plane (S-plane) messages, it is understood that the control plane (C-plane) messages, user plane (U-plane) messages, and synchronization plane (S-plane) messages have a logical communication flow from the O-RAN distributed unit (O-DU) 210, through the master unit 204, and to the radio units (RU) 206, DAS radio units (RU) 206C, or the O-RAN radio units 206E.

FIG. 2A is a block diagram of an example communication system 200A that includes a distributed antenna system (DAS) 202 that includes a master unit 204 and a plurality of radio units (RUs) 206 (including radio unit (RU) 206-1, radio unit (RU) 206-2, and any quantity of RUs 206 through optional radio unit (RU) 206-X). In examples, each RU 206 includes, or is otherwise associated with, a respective set of coverage antennas 208 (including coverage antennas 208-1 for RU 206-1, coverage antennas 208-2 for RU 206-2, and any quantity of coverage antennas 208 through optional coverage antenna 208-X) via which downlink analog RF signals can be radiated to user equipment (UEs) and via which uplink analog RF signals transmitted by UEs can be received. In examples, the master unit 204 is communicatively coupled to the RUs 206 using at least one Ethernet switch. In examples, the master unit 204 can be implemented as master unit 130 as shown in FIGS. 1A-1D and described above; the RUs 206 can be implemented as RU 106 as shown in FIGS. 1A-1D and described above; and the coverage antennas 208 can be implemented as coverage antennas 108 shown in FIGS. 2A-2D and described above. In examples, one or more intermediary combining nodes (ICNs) (such as intermediary combining nodes (ICNs) 112 described above) are included between the master unit 204 and the radio units (RU) 206).

In examples, the master unit 204 of the distributed antenna system (DAS) 202 is communicatively coupled with an O-RAN distributed unit (O-DU) 210 of a Open Radio Access Network (O-RAN) 212. In examples, other distributed units of other radio access networks (RAN) are used instead of the O-RAN distributed unit (O-DU) 210. In examples, the master unit 204 is also communicatively coupled to a service management and orchestration (SMO) 214 of the Open Radio Access Network (O-RAN) 212, which communicates management plane messages with the master unit 204. In examples, other devices or functions (such as RAN Service Management (RSM), a service orchestrator (SO), or other devices or functions other than the O-RAN distributed unit (O-DU) 210) are used instead of (or in addition to) the service management and orchestration (SMO) 214.

In examples, any of the communication system 200A, the distributed antenna system (DAS) 202, the master unit 204, the radio units (RU) 206, the O-RAN distributed unit (O-DU) 210, the Open Radio Access Network (O-RAN) 212, the service management and orchestration (SMO) 214, and any of the specific features described here as being implemented thereby, can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented by the software. Such hardware or software (or portions thereof) can be implemented in other ways (for example, in an application specific integrated circuit (ASIC), field programmable gate array (FPGA), etc.). Such entities can be implemented in other ways.

In examples, the master unit 204 is configured to receive downlink control plane messages, downlink user plane messages, and uplink control plane messages from the O-RAN distributed unit (O-DU) 210 of the open radio access network (O-RAN) 212. In examples, the master unit 204 is configured to copy and forward the downlink control plane messages, the downlink user plane messages, and the uplink control plane messages to a plurality of radio units 206 of the distributed antenna system (DAS) 202. In other examples, the master unit 204 is configured to copy and forward the downlink control plane messages, the downlink user plane messages, and the uplink control plane messages to a single radio unit 206 of the distributed antenna system (DAS) 202. In examples, the master unit 204 is configured to receive and perform any needed combining or summing of uplink user plane messages from a plurality of radio units 206 of the distributed antenna system (DAS) 202. In examples, the master unit 204 is configured to modify the format, headers, compression schemes, and content of the control plane and user plane messages before sending them to radio units 206. In examples, the master unit 204 is configured to modify the format of fronthaul packets or the content of the headers for the control plane or user plane.

In examples, master unit 204 is configured to manage any of the radio units 206 of the distributed antenna system (DAS) 202 by communicating management plane messages with the radio units 206 of the distributed antenna system (DAS) 202. In examples, the master unit 204 is configured to manage the plurality of radio units by being configured to: (1) perform topology discover of the plurality of radio units; (2) configure management plane links to each radio unit of the plurality of radio units; and/or (3) manage configuration of each radio unit of the plurality of radio units. In examples, the master unit 204 is configured to receive management plane messages from the O-RAN distributed unit (O-DU) 210 of the open radio access network (O-RAN) 212. In examples, the master unit 204 is configured to receive additional management plane messages from the service management and orchestration (SMO) 214 or other devices or functions (such as RAN Service Management (RSM), a service orchestrator (SO), or other devices or functions other than the O-RAN distributed unit (O-DU) 210). In examples, the management plane messages communicated from the master unit 204 to the radio units 206 are based on the management plane messages received at the master unit 204 from the O-RAN distributed unit (O-DU) 210 and/or the service management and orchestration (SMO) 214 or other devices or functions (such as RAN Service Management (RSM), a service orchestrator (SO), or other devices or functions other than the O-RAN distributed unit (O-DU) 210).

Accordingly, management of the radio units 206 by the master unit 204 may occur through management plane messages communicated between the master unit 204 and the radio units 206 and may be based on management plane messages received from the O-RAN distributed unit (O-DU) 210 of the open radio access network (O-RAN) 212 and/or the service management and orchestration (SMO) 214 or other devices or functions (such as RAN Service Management (RSM), a service orchestrator (SO), or other devices or functions other than the O-RAN distributed unit (O-DU) 210). In examples, the master unit 204 is configured for hybrid management by both: (1) the O-RAN distributed unit (O-DU) 210 of the open radio access network (O-RAN) 212; and (2) at least one of the service management and orchestration (SMO) 214, a RAN Service Management (RSM), or a service orchestrator (SO).

FIG. 2B is a block diagram of another example communication system 200B with similar components and functionality to example communication system 200A described above. The communication system 200B of FIG. 2B is the same as communication system 200A of FIG. 2A except as described below. In examples of communication system 200B, the service management and orchestration (SMO) 214 (or other devices or functions, such as RAN Service Management (RSM), a service orchestrator (SO), or other devices or functions other than the O-RAN distributed unit (O-DU) 210) provides direct management of the radio units (RU) 206 using management plane messages in addition to the management of the radio units (RUS) 206 from the master unit 204 using management plane messages. Accordingly, management of the radio units 206 may occur in a hybrid mode by both: (1) the master unit 204; and (2) at least one of the service management and orchestration (SMO) 214, a RAN Service Management (RSM), or a service orchestrator (SO).

FIG. 2C is a block diagram of another example communication system 200C with similar components and functionality to example communication system 200A described above. The communication system 200C of FIG. 2C is the same as communication system 200A of FIG. 2A except as described below. In examples of communication system 200C, the radio units (RU) 206 are DAS radio units (RU) 206C (including DAS radio unit (RU) 206C-1, DAS radio unit (RU) 206C-2, and any quantity of optional DAS RUs 206C through optional DAS radio unit (RU) 206C-X).

FIG. 2D is a block diagram of another example communication system 200D with similar components and functionality to example communication system 200B described above. The communication system 200D of FIG. 2D is the same as communication system 200B of FIG. 2B except as described below. In examples of communication system 200B, the radio units (RU) 206 are DAS radio units (RU) 206C (including DAS radio unit (RU) 206C-1, DAS radio unit (RU) 206C-2, and any quantity of optional DAS RUs 206C through optional DAS radio unit (RU) 206C-X).

FIG. 2E is a block diagram of another example communication system 200E with similar components and functionality to example communication system 200A described above. The communication system 200E of FIG. 2E is the same as communication system 200A of FIG. 2A except as described below. In examples of communication system 200E, the radio units (RU) 206 are O-RAN radio units (RU) 206E (including O-RAN radio unit (RU) 206E-1, O-RAN radio unit (RU) 206E-2, and any quantity of optional O-RAN RUs 206E through optional O-RAN radio unit (RU) 206E-X).

FIG. 2F is a block diagram of another example communication system 200F with similar components and functionality to example communication system 200B described above. The communication system 200F of FIG. 2F is the same as communication system 200B of FIG. 2B except as described below. In examples of communication system 200F, the radio units (RU) 206 are O-RAN radio units (RU) 206F (including O-RAN radio unit (RU) 206E-1, O-RAN radio unit (RU) 206E-2, and any quantity of optional O-RAN RUs 206E through optional O-RAN radio unit (RU) 206E-X).

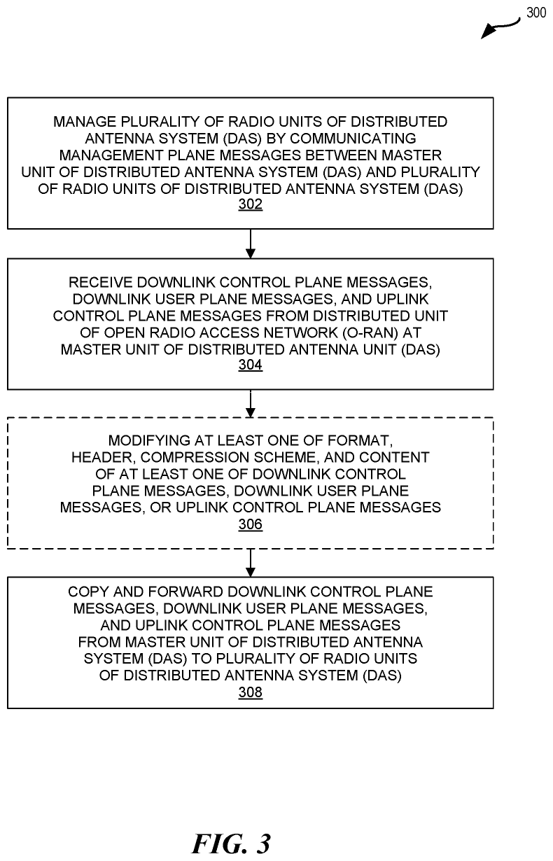

FIG. 3 is a flow diagram illustrating a method 300 implemented using a distributed antenna system (DAS, such as any of DAS 100 or DAS 202 shown in FIGS. 1A-1D and FIGS. 2A-2F and described herein). In examples, method 300 begins at block 302 with managing the plurality of radio units (such as any of RU 106 shown in FIGS. 1A-1D; radio unit (RU) 206-1 through radio unit (RU) 206-X shown in FIGS. 2A-2B; DAS radio unit (RU) 206C-1 through DAS radio unit (RU) 205C-X shown in FIGS. 2C-2D; and O-RAN radio unit (O-RU) 206E-1 through O-RAN radio unit (O-RU) 206E-X shown in FIGS. 2E-2F and described herein) of the distributed antenna system (DAS, such as any of DAS 100 or DAS 202 shown in FIGS. 1A-1D and FIGS. 2A-2F and described herein) by communicating management plane messages between the master unit (such as master unit 130 in FIGS. 1A-1D and master unit 204 in FIGS. 2A-2F and described herein) of the distributed antenna system (DAS, such as any of DAS 100 or DAS 202 shown in FIGS. 1A-1D and FIGS. 2A-2F and described herein) and the plurality of radio units (such as any of RU 106 shown in FIGS. 1A-1D; radio unit (RU) 206-1 through radio unit (RU) 206-X shown in FIGS. 2A-2B; DAS radio unit (RU) 206C-1 through DAS radio unit (RU) 205C-X shown in FIGS. 2C-2D; and O-RAN radio unit (O-RU) 206E-1 through O-RAN radio unit (O-RU) 206E-X shown in FIGS. 2E-2F and described herein) of the distributed antenna system (DAS, such as any of DAS 100 or DAS 202 shown in FIGS. 1A-1D and FIGS. 2A-2F and described herein). In examples, managing the plurality of radio units continues throughout the method 300, while control plane messages and user plane messages are also communicated.

In examples, managing the plurality of radio units includes: (1) performing topology discovery of the plurality of radio units; (2) configuring management plane links to each radio unit of the plurality of radio units; and/or (3) managing configuration of each radio unit of the plurality of radio units. In examples, method 300 further includes receiving management plane messages from the distributed unit of the open radio access network (O-RAN). In examples, method 300 further includes receiving additional management plane messages from the service management and orchestration (SMO) or other devices or functions (such as RAN Service Management (RSM), a service orchestrator (SO), or other devices or functions other than the distributed unit). In examples, the management plane messages communicated from the master unit to the radio units are based on the management plane messages received at the master unit from the distributed unit and/or the service management and orchestration (SMO) or other devices or functions (such as RAN Service Management (RSM), a service orchestrator (SO), or other devices or functions other than the distributed unit).

In examples of method 300, the master unit is configured for hybrid management by both: (1) the distributed unit of the open radio access network (O-RAN); and (2) at least one of the service management and orchestration (SMO), a RAN Service Management (RSM), or a service orchestrator (SO). In examples of method 300, the remote units are managed by both: (1) the master unit; and (2) the at least one of the RAN Service Management (RSM), the service orchestrator (SO), or the service management and orchestration (SMO).

Method 300 proceeds to block 304 with receiving downlink control plane messages, downlink user plane messages, and uplink control plane messages from a distributed unit (such as O-RAN DU 124 in FIGS. 1A-1D or O-RAN distributed unit (O-DU) 210 in FIGS. 2A-2F and described herein) of an open radio access network (O-RAN, such as O-RAN 212 in FIGS. 2A-2F and described herein) at a master unit (such as master unit 130 in FIGS. 1A-1D and master unit 204 in FIGS. 2A-2F and described herein) of the distributed antenna system (DAS, such as any of DAS 100 or DAS 202 shown in FIGS. 1A-1D and FIGS. 2A-2F and described herein).

Method 300 proceeds to optional block 306 with modifying at least one of the format, headers, compression schemes, and content of at least one of the control plane messages or user plane messages.

Method 300 proceeds to block 308 with copying and forwarding the downlink control plane messages, the downlink user plane messages, and the uplink control plane messages from the master unit (such as master unit 130 in FIGS. 1A-1D and master unit 204 in FIGS. 2A-2F and described herein) of the distributed antenna system (DAS, such as any of DAS 100 or DAS 202 shown in FIGS. 1A-1D and FIGS. 2A-2F and described herein) to a plurality of radio units (such as any of RU 106 shown in FIGS. 1A-1D; radio unit (RU) 206-1 through radio unit (RU) 206-X shown in FIGS. 2A-2B; DAS radio unit (RU) 206C-1 through DAS radio unit (RU) 205C-X shown in FIGS. 2C-2D; and O-RAN radio unit (O-RU) 206E-1 through O-RAN radio unit (O-RU) 206E-X shown in FIGS. 2E-2F and described herein) of the distributed antenna system (DAS, such as any of DAS 100 or DAS 202 shown in FIGS. 1A-1D and FIGS. 2A-2F and described herein). In other examples, the master unit is configured to copy and forward the downlink control plane messages, the downlink user plane messages, and the uplink control plane messages to a single radio unit (such as any of RU 106 shown in FIGS. 1A-1D; radio unit (RU) 206-1 through radio unit (RU) 206-X shown in FIGS. 2A-2B; DAS radio unit (RU) 206C-1 through DAS radio unit (RU) 205C-X shown in FIGS. 2C-2D; and O-RAN radio unit (O-RU) 206E-1 through O-RAN radio unit (O-RU) 206E-X shown in FIGS. 2E-2F and described herein) of the distributed antenna system (DAS) 202.

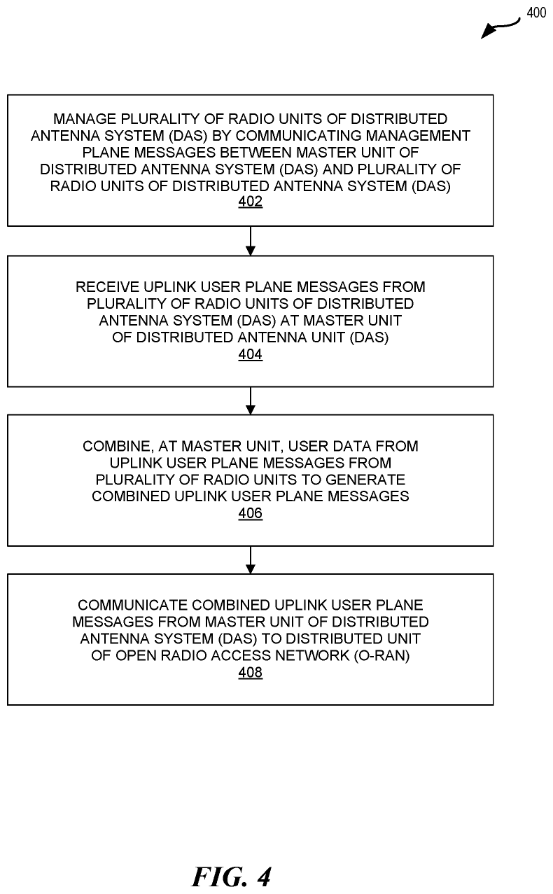

FIG. 4 is a flow diagram illustrating a method 400 implemented using a distributed antenna system (DAS, such as any of DAS 100 or DAS 202 shown in FIGS. 1A-1D and FIGS. 2A-2F and described herein). In examples, method 400 begins at block 402 with managing the plurality of radio units (such as any of RU 106 shown in FIGS. 1A-1D; radio unit (RU) 206-1 through radio unit (RU) 206-X shown in FIGS. 2A-2B; DAS radio unit (RU) 206C-1 through DAS radio unit (RU) 205C-X shown in FIGS. 2C-2D; and O-RAN radio unit (O-RU) 206E-1 through O-RAN radio unit (O-RU) 206E-X shown in FIGS. 2E-2F and described herein) of the distributed antenna system (DAS, such as any of DAS 100 or DAS 202 shown in FIGS. 1A-1D and FIGS. 2A-2F and described herein) by communicating management plane messages between the master unit (such as master unit 130 in FIGS. 1A-1D and master unit 204 in FIGS. 2A-2F and described herein) of the distributed antenna system (DAS, such as any of DAS 100 or DAS 202 shown in FIGS. 1A-1D and FIGS. 2A-2F and described herein) and the plurality of radio units (such as any of RU 106 shown in FIGS. 1A-1D; radio unit (RU) 206-1 through radio unit (RU) 206-X shown in FIGS. 2A-2B; DAS radio unit (RU) 206C-1 through DAS radio unit (RU) 205C-X shown in FIGS. 2C-2D; and O-RAN radio unit (O-RU) 206E-1 through O-RAN radio unit (O-RU) 206E-X shown in FIGS. 2E-2F and described herein) of the distributed antenna system (DAS, such as any of DAS 100 or DAS 202 shown in FIGS. 1A-1D and FIGS. 2A-2F and described herein). In examples, managing the plurality of radio units continues throughout the method 400, while control plane messages and user plane messages are also communicated.

In examples, managing the plurality of radio units includes: (1) performing topology discovery of the plurality of radio units; (2) configuring management plane links to each radio unit of the plurality of radio units; and/or (3) managing configuration of each radio unit of the plurality of radio units. In examples, method 400 further includes receiving management plane messages from the distributed unit of the open radio access network (O-RAN).

In examples, method 400 further includes receiving additional management plane messages from the service management and orchestration (SMO) or other devices or functions (such as RAN Service Management (RSM), a service orchestrator (SO), or other devices or functions other than the distributed unit). In examples, the management plane messages communicated from the master unit to the radio units are based on the management plane messages received at the master unit from the distributed unit and/or the service management and orchestration (SMO) or other devices or functions (such as RAN Service Management (RSM), a service orchestrator (SO), or other devices or functions other than the distributed unit).

In examples of method 400, the master unit is configured for hybrid management by both: (1) the distributed unit of the open radio access network (O-RAN); and (2) at least one of the service management and orchestration (SMO), a RAN Service Management (RSM), or a service orchestrator (SO). In examples of method 400, the remote units are managed by both: (1) the master unit; and (2) the at least one of the RAN Service Management (RSM), the service orchestrator (SO), or the service management and orchestration (SMO).

Method 400 proceeds to block 404 with receiving uplink user plane messages from a plurality of radio units (such as any of RU 106 shown in FIGS. 1A-1D; radio unit (RU) 206-1 through radio unit (RU) 206-X shown in FIGS. 2A-2B; DAS radio unit (RU) 206C-1 through DAS radio unit (RU) 205C-X shown in FIGS. 2C-2D; and O-RAN radio unit (O-RU) 206E-1 through O-RAN radio unit (O-RU) 206E-X shown in FIGS. 2E-2F and described herein) of the distributed antenna system (DAS, such as any of DAS 100 or DAS 202 shown in FIGS. 1A-1D and FIGS. 2A-2F and described herein) at the master unit (such as master unit 130 in FIGS. 1A-1D and master unit 204 in FIGS. 2A-2F and described herein) of the distributed antenna system (DAS, such as any of DAS 100 or DAS 202 shown in FIGS. 1A-1D and FIGS. 2A-2F and described herein). In other examples, the master unit receives uplink user plane messages from a single radio unit (such as any of RU 106 shown in FIGS. 1A-1D; radio unit (RU) 206-1 through radio unit (RU) 206-X shown in FIGS. 2A-2B; DAS radio unit (RU) 206C-1 through DAS radio unit (RU) 205C-X shown in FIGS. 2C-2D; and O-RAN radio unit (O-RU) 206E-1 through O-RAN radio unit (O-RU) 206E-X shown in FIGS. 2E-2F and described herein) of the distributed antenna system (DAS, such as any of DAS 100 or DAS 202 shown in FIGS. 1A-1D and FIGS. 2A-2F and described herein) at the master unit (such as master unit 130 in FIGS. 1A-1D and master unit 204 in FIGS. 2A-2F and described herein) of the distributed antenna system (DAS, such as any of DAS 100 or DAS 202 shown in FIGS. 1A-1D and FIGS. 2A-2F and described herein).

Method 400 proceeds to block 406 with combining, at the master unit, user data from the uplink user plane messages from the plurality of radio units to generate combined uplink user plane messages. In examples, the combining is an uplink summation. In examples, the combining is uplink coherent combining that requires phase information for the data. In examples, the master unit 204 is configured to modify the format, headers, compression schemes, and content of the combined uplink user plane messages before sending them to the master unit. In examples, the master unit 204 is configured to modify the format of packets or content of the headers for the control plane or user plane.

Method 400 proceeds to block 406 with communicating the combined uplink user plane messages from the master unit (such as master unit 130 in FIGS. 1A-1D and master unit 204 in FIGS. 2A-2F and described herein) of the distributed antenna system (DAS, such as any of DAS 100 or DAS 202 shown in FIGS. 1A-1D and FIGS. 2A-2F and described herein) to a distributed unit (such as O-RAN DU 124 in FIGS. 1A-1D or O-RAN distributed unit (O-DU) 210 in FIGS. 2A-2F and described herein) of an open radio access network (O-RAN, such as O-RAN 212 in FIGS. 2A-2F and described herein).

The methods disclosed herein comprise one or more steps or actions for achieving the described method. Unless a specific order of steps or actions is required for proper operation of the method that is being described, the order and/or use of specific steps and/or actions may be modified without departing from the scope of the claims.

While detailed descriptions of one or more configurations of the disclosure have been given above, various alternatives, modifications, and equivalents will be apparent to those skilled in the art without varying from the spirit of the disclosure. For example, while the configurations described above refer to particular features, functions, procedures, components, elements, and/or structures, the scope of this disclosure also includes configurations having different combinations of features, functions, procedures, components, elements, and/or structures, and configurations that do not include all of the described features, functions, procedures, components, elements, and/or structures. Accordingly, the scope of the present disclosure is intended to embrace all such alternatives, modifications, and variations as fall within the scope of the claims, together with all equivalents thereof. Therefore, the above description should not be taken as limiting.

### EXAMPLES

Example 1 includes a master unit for use within a distributed antenna system, the master unit comprising: circuitry configured to: manage a plurality of radio units of the distributed antenna system by communicating management plane messages with the plurality of radio units of the distributed antenna system; receive downlink control plane messages, downlink user plane messages, and uplink control plane messages from a distributed unit of an open radio access network; and copy and forward the downlink control plane messages, the downlink user plane messages, and the uplink control plane messages to the plurality of radio units of the distributed antenna system.

Example 2 includes the master unit of Example 1, wherein the circuitry is further configured to manage the plurality of radio units by being configured to: perform topology discovery of the plurality of radio units; configure management plane links to each radio unit of the plurality of radio units; and manage configuration of each radio unit of the plurality of radio units.

Example 3 includes the master unit of any of Examples 1-2, wherein the circuitry is configured to: modify at least one of a format, a header, a compression scheme, or content of at least one of the downlink control plane messages, the downlink user plane messages, or the uplink control plane messages.

Example 4 includes the master unit of any of Examples 1-3, wherein the circuitry is further configured to: receive second management plane messages from the distributed unit of the open radio access network.

Example 5 includes the master unit of Example 4, wherein the circuitry is further configured to: receive third management plane messages from at least one of a RAN Service Management (RSM), a service orchestrator (SO), or a service management and orchestration (SMO).

Example 6 includes the master unit of Example 5, wherein the circuitry is further configured for hybrid management by both: (1) the distributed unit of the open radio access network; and (2) the at least one of the RAN Service Management (RSM), the service orchestrator (SO), or the service management and orchestration (SMO).

Example 7 includes the master unit of Example 6, wherein the plurality of radio units are only directly managed by the master unit.

Example 8 includes the master unit of any of Examples 6-7, wherein the plurality of radio units are managed by both: (1) the master unit; and (2) the at least one of the RAN Service Management (RSM), the service orchestrator (SO), or the service management and orchestration (SMO).

Example 9 includes a distributed antenna system, the distributed antenna system comprising: a master unit communicatively coupled to a distributed unit of an open radio access network implementing a shared cell; a plurality of radio units communicatively coupled to the distributed unit, wherein each of the plurality of radio units includes circuitry for exchanging radio frequency signals with at least one user equipment; and wherein the master unit is configured to: manage the plurality of radio units of the distributed antenna system by communicating management plane messages with the plurality of radio units; receive downlink control plane messages, downlink user plane messages, and uplink control plane messages from the distributed unit of the open radio access network; and copy and forward the downlink control plane messages, the downlink user plane messages, and the uplink control plane messages to the plurality of radio units.

Example 10 includes the distributed antenna system of Example 9, wherein the master unit is configured to manage the plurality of radio units by being configured to: perform topology discovery of the plurality of radio units; configure management plane links to each radio unit of the plurality of radio units; and manage configuration of each radio unit of the plurality of radio units.

Example 11 includes the distributed antenna system of any of Examples 9-10, wherein the master unit is is configured to: modify at least one of a format, a header, a compression scheme, or content of at least one of the downlink control plane messages, the downlink user plane messages, or the uplink control plane messages.

Example 12 includes the distributed antenna system of any of Examples 9-11, wherein the master unit is further configured to: receive second management plane messages from the distributed unit of the open radio access network.

Example 13 includes the distributed antenna system of Example 12, wherein the master unit is further configured to: receive third management plane messages from at least one of a RAN Service Management (RSM), a service orchestrator (SO), or a service management and orchestration (SMO).

Example 14 includes the distributed antenna system of Example 13, wherein the master unit is further configured for hybrid management by both: (1) the distributed unit of the open radio access network; and (2) the at least one of the RAN Service Management (RSM), the service orchestrator (SO), or the service management and orchestration (SMO).

Example 15 includes the distributed antenna system of Example 14, wherein the plurality of radio units are only directly managed by the master unit.

Example 16 includes the distributed antenna system of any of Examples 14-15, wherein the plurality of radio units are managed by both: (1) the master unit; and (2) the at least one of the RAN Service Management (RSM), the service orchestrator (SO), or the service management and orchestration (SMO).

Example 17 includes a method comprising: managing a plurality of radio units of a distributed antenna system by communicating management plane messages between a master unit of the distributed antenna system and the plurality of radio units of the distributed antenna system; receiving downlink control plane messages, downlink user plane messages, and uplink control plane messages from a distributed unit of an open radio access network at the master unit of the distributed antenna system; and copying and forwarding the downlink control plane messages, the downlink user plane messages, and the uplink control plane messages from the master unit of the distributed antenna system to the plurality of radio units of the distributed antenna system.

Example 18 includes the method of Example 17, wherein managing the plurality of radio units includes: performing topology discovery of the plurality of radio units; configuring management plane links to each radio unit of the plurality of radio units; and managing configuration of each radio unit of the plurality of radio units.

Example 19 includes the method of any of Examples 17-18, further comprising: modifying at least one of a format, a header, a compression scheme, or content of at least one of the downlink control plane messages, the downlink user plane messages, or the uplink control plane messages.

Example 20 includes the method of any of Examples 17-19, further comprising: receiving second management plane messages at the master unit of the distributed antenna system from the distributed unit of the open radio access network.

Example 21 includes the method of Example 20, further comprising: receiving third management plane messages at the master unit of the distributed antenna system from at least one of a RAN Service Management (RSM), a service orchestrator (SO), or a service management and orchestration (SMO).

Example 22 includes the method of Example 21, wherein the master unit is configured for hybrid management by both: (1) the distributed unit of the open radio access network; and (2) the at least one of the RAN Service Management (RSM), the service orchestrator (SO), or the service management and orchestration (SMO).

Example 23 includes the method of Example 22, wherein the plurality of radio units are only directly managed by the master unit.

Example 24 includes the method of any of Examples 22-23, wherein the plurality of radio units are managed by both: (1) the master unit; and (2) the at least one of the RAN Service Management (RSM), the service orchestrator (SO), or the service management and orchestration (SMO).

What is claimed is:

1. A master unit for use within a distributed antenna system, the master unit comprising: circuitry configured to:
manage a plurality of radio units of the distributed antenna system by communicating management plane messages with the plurality of radio units of the distributed antenna system;
receive downlink control plane messages, downlink user plane messages, and uplink control plane messages from a distributed unit of an open radio access network; and
copy and forward the downlink control plane messages, the downlink user plane messages, and the uplink control plane messages to the plurality of radio units of the distributed antenna system.

2. The master unit of claim 1, wherein the circuitry is further configured to manage the plurality of radio units by being configured to:
perform topology discovery of the plurality of radio units;
configure management plane links to each radio unit of the plurality of radio units; and
manage configuration of each radio unit of the plurality of radio units.

3. The master unit of claim 1, wherein the circuitry is configured to:
modify at least one of a format, a header, a compression scheme, or content of at least one of the downlink control plane messages, the downlink user plane messages, or the uplink control plane messages.

4. The master unit of claim 1, wherein the circuitry is further configured to:
receive second management plane messages from the distributed unit of the open radio access network.

5. The master unit of claim 4, wherein the circuitry is further configured to:
receive third management plane messages from at least one of a RAN Service Management (RSM), a service orchestrator (SO), or a service management and orchestration (SMO).

6. The master unit of claim 5, wherein the circuitry is further configured for hybrid management by both: (1) the distributed unit of the open radio access network; and (2) the at least one of the RAN Service Management (RSM), the service orchestrator (SO), or the service management and orchestration (SMO).

7. The master unit of claim 6, wherein the plurality of radio units are only directly managed by the master unit.

8. The master unit of claim 6, wherein the plurality of radio units are managed by both: (1) the master unit; and (2) the at least one of the RAN Service Management (RSM), the service orchestrator (SO), or the service management and orchestration (SMO).

9. A distributed antenna system, the distributed antenna system comprising:
a master unit communicatively coupled to a distributed unit of an open radio access network implementing a shared cell;
a plurality of radio units communicatively coupled to the distributed unit, wherein each of the plurality of radio units includes circuitry for exchanging radio frequency signals with at least one user equipment; and
wherein the master unit is configured to:
manage the plurality of radio units of the distributed antenna system by communicating management plane messages with the plurality of radio units;
receive downlink control plane messages, downlink user plane messages, and uplink control plane messages from the distributed unit of the open radio access network; and
copy and forward the downlink control plane messages, the downlink user plane messages, and the uplink control plane messages to the plurality of radio units.

10. The distributed antenna system of claim 9, wherein the master unit is configured to manage the plurality of radio units by being configured to:
perform topology discovery of the plurality of radio units;
configure management plane links to each radio unit of the plurality of radio units; and
manage configuration of each radio unit of the plurality of radio units.

11. The distributed antenna system of claim 9, wherein the master unit is is configured to:
modify at least one of a format, a header, a compression scheme, or content of at least one of the downlink control plane messages, the downlink user plane messages, or the uplink control plane messages.

12. The distributed antenna system of claim 9, wherein the master unit is further configured to:
receive second management plane messages from the distributed unit of the open radio access network.

13. The distributed antenna system of claim 12, wherein the master unit is further configured to:
receive third management plane messages from at least one of a RAN Service Management (RSM), a service orchestrator (SO), or a service management and orchestration (SMO).

14. The distributed antenna system of claim 13, wherein the master unit is further configured for hybrid management by both: (1) the distributed unit of the open radio access network; and (2) the at least one of the RAN Service Management (RSM), the service orchestrator (SO), or the service management and orchestration (SMO).

15. The distributed antenna system of claim 14, wherein the plurality of radio units are only directly managed by the master unit.

16. The distributed antenna system of claim 14, wherein the plurality of radio units are managed by both: (1) the master unit; and (2) the at least one of the RAN Service Management (RSM), the service orchestrator (SO), or the service management and orchestration (SMO).

17. A method comprising:
managing a plurality of radio units of a distributed antenna system by communicating management plane messages between a master unit of the distributed antenna system and the plurality of radio units of the distributed antenna system;
receiving downlink control plane messages, downlink user plane messages, and uplink control plane messages from a distributed unit of an open radio access network at the master unit of the distributed antenna system; and
copying and forwarding the downlink control plane messages, the downlink user plane messages, and the uplink control plane messages from the master unit of the distributed antenna system to the plurality of radio units of the distributed antenna system.

18. The method of claim 17, wherein managing the plurality of radio units includes:
performing topology discovery of the plurality of radio units;
configuring management plane links to each radio unit of the plurality of radio units; and
managing configuration of each radio unit of the plurality of radio units.

19. The method of claim 17, further comprising:
modifying at least one of a format, a header, a compression scheme, or content of at least one of the downlink control plane messages, the downlink user plane messages, or the uplink control plane messages.

20. The method of claim 17, further comprising:
receiving second management plane messages at the master unit of the distributed antenna system from the distributed unit of the open radio access network.

21. The method of claim 20, further comprising:
receiving third management plane messages at the master unit of the distributed antenna system from at least one of a RAN Service Management (RSM), a service orchestrator (SO), or a service management and orchestration (SMO).

22. The method of claim 21, wherein the master unit is configured for hybrid management by both: (1) the distributed unit of the open radio access network; and (2) the at least one of the RAN Service Management (RSM), the service orchestrator (SO), or the service management and orchestration (SMO).

23. The method of claim 22, wherein the plurality of radio units are only directly managed by the master unit.

24. The method of claim 22, wherein the plurality of radio units are managed by both: (1) the master unit; and (2) the at least one of the RAN Service Management (RSM), the service orchestrator (SO), or the service management and orchestration (SMO).
